(19) United States
(12) Patent Application Publication
(10) Pub. No.: US 2010/0195200 A1
(43) Pub. Date: Aug. 5, 2010

(54) SCREEN, CONTROL METHOD, PROGRAM, AND RECORDING MEDIUM

(75) Inventors: Tetsujiro Kondo, Tokyo (JP); Akihiko Arimitsu, Kanagawa (JP); Junichi Shima, Kanagawa (JP); Takuro Ema, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/668,851

(22) PCT Filed: Jul. 25, 2008
(86) PCT No.: PCT/JP08/63350

§ 371 Date: Jan. 12, 2010

(30) Foreign Application Priority Data
Jul. 26, 2007 (JP) 2007-194508

(51) Int. Cl. G03B 21/56; H04R 25/00; H04R 5/02

(52) U.S. Cl. 359/449; 381/150; 381/304

(57) ABSTRACT

The present invention relates to a screen, a control method, a program, and a recording medium that can provide audio and video at an optimal position for a user.

A beam 111 is fixed to a frame 24. The beam 111 is connected to a beam 112 through a rotation shaft 113. Wheels 23A, 23B are fixed to the beam 112, and the wheels 23A, 23B allows movement along a rail provided in a ceiling. A speaker, a display, etc., is mounted on the frame 24. In a case in which the speaker is mounted, when the frame 24 is rotated around the rotation shaft 113, the front surface of the speaker can be directed toward a position of a user. The present invention may be applied to, for example, a screen speaker device.

### TECHNICAL FIELD

The present invention relates to screens, control methods, programs, and recording media, and more particularly relates to a screen, a control method, a program, and a recording medium that can move a speaker and a display so that the position of a user becomes an optimal position when video, audio, etc., are provided.

### BACKGROUND ART

FIG. 1 is an illustration showing a configuration of a conventional screen speaker device 11 (for example, see Patent Document 1). The screen speaker device 11 functions as a speaker and also serves as a screen. The screen speaker device 11 is supported such that wheels 23A, 23B are fitted into a guide 22 provided in a ceiling 21.

The screen speaker device 11 includes the wheels 23A, 23B, a frame 24, plates 25A-1 to 25B-3, vibration members 31-1 to 31-3, and vibrators 41A to 43C.

The wheel 23A and the wheel 23B are fixed to the frame 24. The frame 24 includes a mechanism for fixing the vibration members 31-1 to 31-3 in a direction in which a load is applied (the vertical direction), and the plates 25A-1 to 25B-3 for fixing the vibration members 31-1 to 31-3 in the front-back direction in the drawing. The vibration members 31-1 to 31-3 are fixed in a detachably attached manner because of the support with these components. With the frame 24 and the plates 25A-1 to 25B-3, the vibration members 31-1 to 31-3 are fixed in the vertical direction and the front-back direction.

Each of the vibration members 31-1 to 31-3 is formed of a material, for example, a wood member, such as a gypsum board or a MDF (Medium Density Fiberboard); an aluminum plate; carbon; resin such as acryl; or glass, and is formed into a plate-like shape. Also, each of the vibration members 31-1 to 31-3 may be formed of a composite material, in which different materials are combined (laminated).

Also, each of the vibration members 31-1 to 31-3 has a plurality of vibrators (in FIG. 1, three vibrators) attached thereto and arranged in a horizontal line in the drawing. Vibrators 41A to 41C, vibrators 42A to 42C, and vibrators 43A to 43C are respectively attached to the vibration member 31-1, the vibration member 31-2, and the vibration member 31-3, and respectively arranged in horizontal lines in the drawings.

Then, for example, the vibrators 41A to 43C driven by a sound source (not shown), such as an amplifier, respectively cause the vibration members 31-1 to 31-3 to vibrate in accordance with audio signals input from the sound source. Hence the vibration members 31-1 to 31-3 output audio. That is, the screen speaker device 11 serves as a speaker that converts audio signals into audio.

Also, the vibrators 41A to 43C are respectively arranged at predetermined positions in a detachably attached manner depending on vibration characteristics of the vibration members 31-1 to 31-3.
Patent Document 1: Japanese Unexamined Patent Application Publication No. 2007-67538

### DISCLOSURE OF INVENTION

### Technical Problem

The screen speaker device 11 shown in FIG. 1 is disposed movably along the guide 22. Thus, a user can move the screen speaker device 11 to a desirable position, and the user can enjoy the audio output from the screen speaker device 11.

However, the position to which the screen speaker device 11 shown in FIG. 1 can be moved is limited to the location where the guide 22 is disposed, and hence, for example, the screen speaker device 11 may not be always disposed at a position at which the relative angle between the user and the screen speaker device 11 allows optimal volume to be obtained.

For example, a case is considered, in which the user and the screen speaker device 11 have a positional relationship shown in FIG. 2. A user 61 is located at a position at an angle Θ with respect to a position in front of the screen speaker device 11. An acoustic wave is output from the front surface of the screen speaker device 11 in a front direction. The acoustic-wave-outputting direction is the same as a wave-propagating-direction of sound. Thus, in the state shown in FIG. 2, the user 61 is located at a position deviated by the angle Θ. This may result in an acoustic transmission loss being produced.

Thus, in this case, the relative angle between the user 61 and the screen speaker device 11 does not achieve the positional relationship that allows the optimal volume to be obtained. If the screen speaker device 11 cannot be moved from the position shown in FIG. 2 on account of the guide 22, the user 61 has to move to a position in front of the screen speaker device 11, to improve the positional relationship to attain the optimal positional relationship.

In addition to the audio output from the screen speaker device 11, video and light may not reach the location of the user. For example, if the user wants to watch video from a television receiver at an optimal position, the position of the television receiver has to be changed, or the user has to move.

The present invention is made in light of the situation, and the present invention can cause audio, video, etc., to be provided at an optimal position.

### Technical Solution

A screen according to an aspect of the present invention includes a rotation section that rotates a frame having a predetermined shape, and the rotation of the frame is controlled such that the frame is directed in a predetermined direction.

The rotation section may be provided for each of a plurality of the frames, and rotation of each frame may be controlled.

A vibration member may be mounted on the frame.

The rotation section may control the rotation such that the vibration member is directed toward a position of a user.

A vibration member may be mounted on each frame. Each rotation section may control the rotation such that the corresponding vibration member is directed toward a position of a user.

The rotation section may analyze sound collected by a sensor that collects sound from the vibration member, and control the rotation such that an intensity of the sound becomes a proper intensity.

A display may be mounted on the frame.

The rotation section may control the rotation such that the display is directed toward a position of a user.

A display may be mounted on each frame. Each rotation section may control the rotation such that the corresponding display is directed toward a position of a user.

A mirror may be mounted on the frame.

The rotation section may control the rotation such that the mirror is directed toward a position of a predetermined object.

A mirror may be mounted on each frame. Each rotation section may control the rotation such that the corresponding mirror is directed toward a position of a predetermined object.

The rotation section may measure an intensity of light with which the object is irradiated, and control the rotation such that the measurement result falls within a predetermined range.

Members having different functions may be mounted respectively on the plurality of frames.

A movement section that moves the frame may be further provided.

With the screen according to the aspect of the present invention, the screen includes the frame having the predetermined shape. A device that outputs sound, a device that outputs an image, a mirror, etc., is mounted on the frame. Also, the frame is rotated in a direction toward the user while the device is mounted.

A control method according to another aspect of the present invention is provided for controlling a rotation section of a screen that includes a frame having a predetermined shape. The control method includes the step of performing control on the basis of data input from an external sensor such that the frame is directed toward the sensor.

Rotation sections respectively provided for a plurality of the frames may be individually controlled.

A vibration member may be mounted on the frame, and control may be provided such that the vibration member is directed toward a position of a user.

Sound collected by a sensor that collects sound from the vibration member may be analyzed, and control may be provided such that an intensity of the sound becomes a proper intensity.

A display may be mounted on the frame, and control may be provided such that the display is directed toward a position of a user.

A mirror may be mounted on the frame, and control may be provided such that the mirror is directed toward a position of a predetermined object.

An intensity of light with which the object is irradiated may be measured, and control may be provided such that the measurement result falls within a predetermined range.

A program according to still another aspect of the present invention causes a computer to execute processing including the steps of controlling a control section that controls a rotation section of a screen that includes a frame having a predetermined shape; and performing control on the basis of data input from an external sensor such that the frame is directed toward the sensor.

A recording medium according to yet another aspect of the present invention stores the above-described program.

With the control method, program, and recording medium according to the aspects of the present invention, the rotation section attached to the frame having the predetermined shape is controlled to be directed in a predetermined direction. The control is performed on the basis of information obtained from the sensor.

### Advantageous Effects

With the aspects of the present invention, audio and video can be provided at an optimal position.

### BRIEF DESCRIPTION OF DRAWINGS

FIG. 1 is an illustration showing an example configuration of a conventional screen speaker device.

FIG. 2 is an illustration explaining an acoustic transmission loss.

FIG. 3 is an illustration showing a configuration according to an embodiment of a screen speaker device to which the present invention is applied.

FIG. 4 is an illustration explaining a frame structure.

FIG. 5 is an illustration explaining a structure of a rotation mechanism.

FIG. 6 is an illustration explaining the structure of the rotation mechanism.

FIG. 7 is an illustration showing an example configuration of a control unit.

FIG. 8 is a flowchart explaining rotation control of a motor.

FIG. 9 is an illustration explaining how to detect the position of a user.

FIG. 10 is an illustration explaining a case in which displays are mounted on the frame.

FIG. 11 is an illustration explaining a case in which devices having different functions are mounted on the frame.

FIG. 12 is an illustration explaining a case in which a mirror is mounted on the frame.

FIG. 13 is an illustration showing an example configuration of a system relating to control of rotation of the mirror.

FIG. 14 is an illustration showing an example configuration of a control unit.

FIG. 15 is a flowchart explaining rotation control of the motor.

FIG. 16 is an illustration explaining frame structures having a plurality of rotation shafts.

FIG. 17 is an illustration explaining a configuration that is used as a speaker.

FIG. 18 is an illustration explaining arrangement of the speaker.

FIG. 19 is an illustration showing an example configuration of a control unit.

FIG. 20 is an illustration explaining rotation control of the motor.

FIG. 21 is an illustration explaining a recording medium.

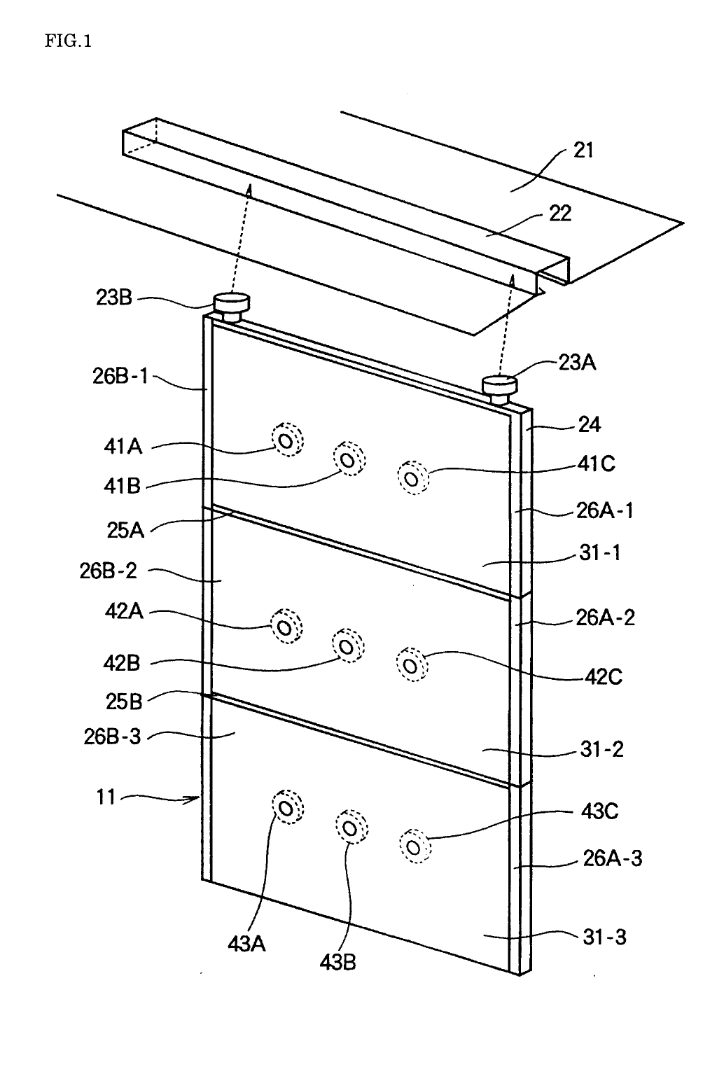

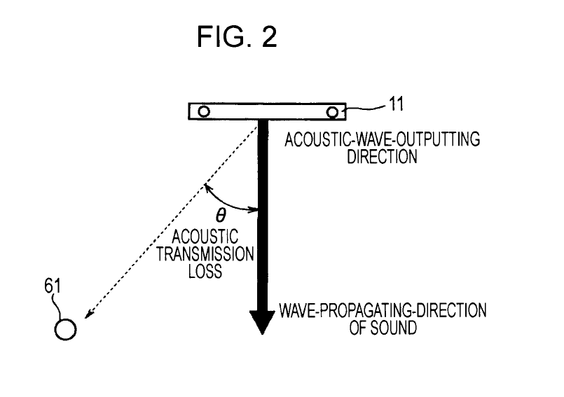

### EXPLANATION OF REFERENCE NUMERALS

21 ceiling, 22 guide, 23 wheel, 24 frame, 25 plate, 31 vibration member, 41 vibrator, 101 screen speaker device, 111, 112 beam, 113 rotation shaft, 114, 115 tap hole, 116 lock mechanism, 117 beam, 118 tap hole, 151 motor, 152 pulley, 161 belt, 201 remote controller data processor, 202 rotation controller, 203 video data processor, 204 background data holder, 231 display, 251 mirror, 301 photosensor, 331 remote controller data processor, 332 rotation controller, 333 photosensor data processor, 403, 413 sensor, 451 audio selector, 452 tone controller, 453 first rotation controller, 454 second rotation controller, 455 sensor data processor

### BEST MODES FOR CARRYING OUT THE INVENTION

Embodiments of the present invention will be described below with reference to the drawings.

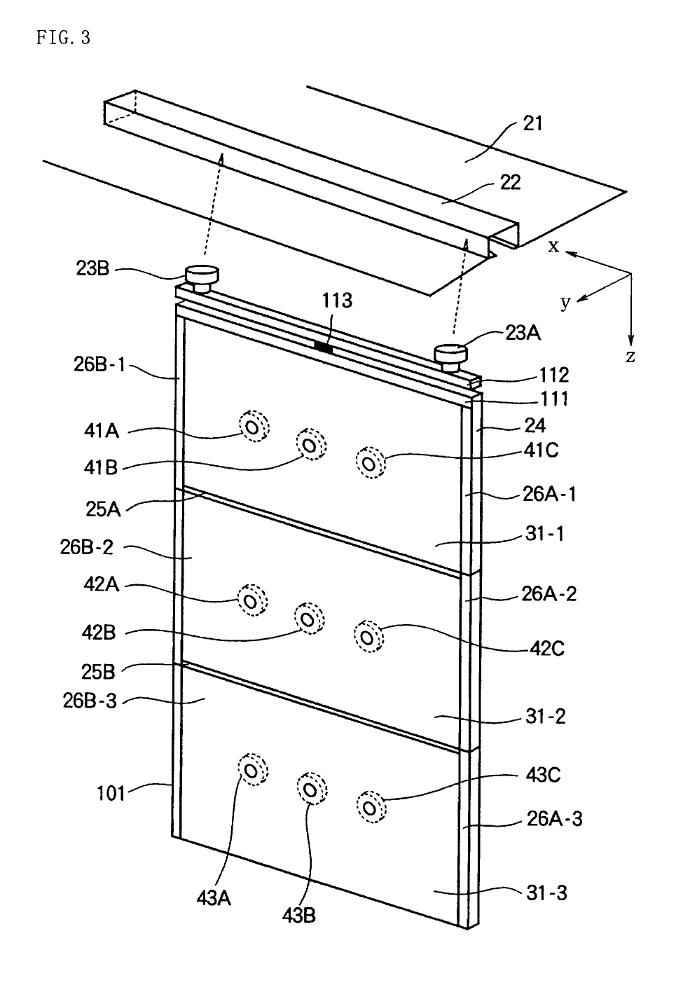

FIG. 3 is an illustration showing a configuration of a screen speaker device 11 according to an embodiment of the present invention. The screen speaker device 101 is an example of an audio output device of the present invention that functions as a speaker and also serves as a screen.

The screen speaker device 101 is supported such that a wheel 23A and a wheel 23B are fitted into a guide 22 provided in a ceiling 21.

The screen speaker device 101 includes the wheels 23A, 23B, a frame 24, plates 25A-1 to 25B-3, vibration members 31-1 to 31-3, and vibrators 41A to 43C.

The wheel 23A and the wheel 23B are fixed to a beam 112. The beam 112 is connected to a beam 111 through a rotation shaft 113. The beam 111 is fixed to the frame 24. The frame 24 includes a mechanism for fixing the vibration members 31-1 to 31-3 in a direction in which a load is applied (the vertical direction), and the plates 25A-1 to 25B-3 for fixing the vibration members 31-1 to 31-3 in the front-back direction in the drawing.

The vibration members 31-1 to 31-3 are fixed in a detachably attached manner because of the support with these components. With the frame 24 and the plates 25A-1 to 25B-3, the vibration members 31-1 to 31-3 are fixed.

Each of the vibration members 31-1 to 31-3 is formed of a material, for example, a wood member, such as a gypsum board or a MDF (Medium Density Fiberboard); an aluminum plate; carbon; resin such as acryl; or glass, and is formed into a plate-like shape. Also, each of the vibration members 31-1 to 31-3 may be formed of a composite material, in which different materials are combined (laminated).

Also, each of the vibration members 31-1 to 31-3 has a plurality of vibrators (in FIG. 3, three vibrators) attached thereto and arranged in a horizontal line in the drawing. Vibrators 41A to 41C, vibrators 42A to 42C, and vibrators 43A to 43C are respectively attached to the vibration member 31-1, the vibration member 31-2, and the vibration member 31-3, and respectively arranged in horizontal lines in the drawings.

Then, for example, the vibrators 41A to 43C driven by a sound source (not shown), such as an amplifier, respectively cause the vibration members 31-1 to 31-3 to vibrate in accordance with audio signals input from the sound source. Hence the vibration members 31-1 to 31-3 output audio. That is, the screen speaker device 101 serves as a speaker that converts audio signals into audio.

Also, the vibrators 41A to 43C are respectively arranged at predetermined positions in a detachably attached manner depending on vibration characteristics of the vibration members 31-1 to 31-3.

In the example in FIG. 3, the screen speaker device 101 fixes the three vibration members including the vibration members 31-1 to 31-3. In the present invention, however, the number of vibration members 31 is not limited to three, and a single vibration member or a plurality of vibration members may be fixed in a detachably attached manner. That is, a user can change the height of the screen speaker device 101 to a desirable height by desirably combining the vibration members 31 in the vertical direction.

In the following description, when the plates 25A-1 to 25B-3 do not have to be distinguished from one another, those plates are merely called plates 25. When the plate 25A-1, the plate 25A-2, and the plate 25A-3 do not have to be distinguished from one another, those plates are merely called plates 25A. When the plate 25B-1, the plate 25B-2, and the plate 25B-3 do not have to be distinguished from one another, those plates are merely called plates 25B.

Also, in the following description, the left-right direction of the screen speaker device 101 (the left-right direction in FIG. 3) represents the x-axis direction, the front-back direction (the direction penetrating through the drawing plane in FIG. 3) represents the y-axis direction, and the up-down direction (the up-down direction in FIG. 3) represents the z-axis direction.

The screen speaker device 101 shown in FIG. 3 has a structure including the rotation shaft 113. Hence, the frame 24 can be rotated around the rotation shaft 113. The screen speaker device 101 can be moved along the guide 22. Further, the direction of the frame 24 can be changed by the rotation of the frame 24 around the rotation shaft 113 at a position after the screen speaker device 101 has been moved. That is, the screen speaker device 101 can be greatly moved along the guide 22, and the angle can be finely adjusted by the rotation shaft 113.

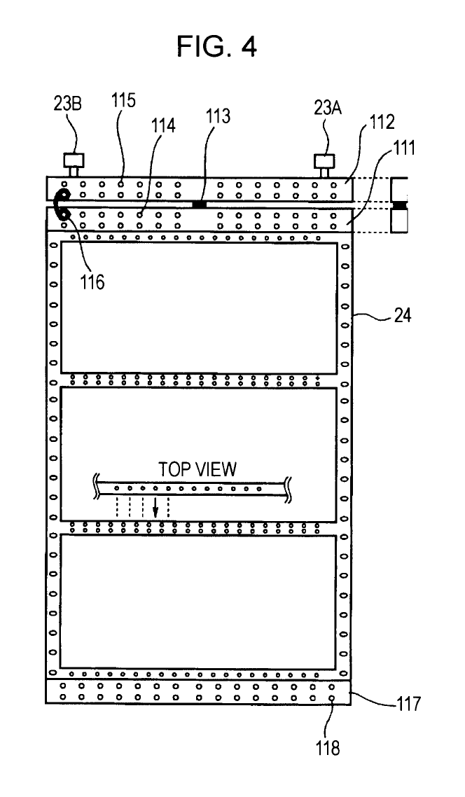

FIG. 4 is an illustration showing a frame structure of the screen speaker device 101 shown in FIG. 3. The frame 24 has a large number of holes for attachment of the vibration members 31. The vibration members 31 are fixed to the frame 24 by the holes and clamps, such as bolts and nuts.

The beam 111, the beam 112, and a beam 117 respectively have tap holes 114, tap holes 115, and tap holes 118. The tap holes 114 of the beam 111 and the tap holes 115 of the beam 112 are provided to provide a lock mechanism 116. Although the frame 24 has the structure rotatable around the rotation shaft 113, for example, when the screen speaker device 101 is moved along the guide 22, it is difficult to move the screen speaker device 101 if the frame 24 is rotated. Also, this is not preferable for safety. The lock mechanism 116 is provided to prevent the rotation during the movement.

The lock mechanism 116 shown in FIG. 4 prevents the relative positions between the beam 111 and the beam 112 from being deviated from one another because the lock mechanism 116 penetrates through the tap hole 114 and the tap hole 115, and is fixed while penetrating through the tap hole 114 and the tap hole 115. When the lock mechanism 116 is configured to engage with the beam 111 and the beam 112, the number of tap holes 114 and the number of tap holes 115 each do not have to be plural as shown in FIG. 4. The tap holes 114 and the tap holes 115 each may be provided by a number that can provide the lock mechanism 116. Also, the shape of the lock mechanism 116 is not limited to the shape shown in FIG. 4, and may be any shape as long as the mechanism prevents the relative positions between the beam 111 and the beam 112 from being deviated from predetermined positions.

The beam 117 is attached to the bottom of the frame 24. The tap holes 118 are provided in the beam 117 for attachment of a sensor etc. Here, description continues on the basis of that the beam 117 is provided at the bottom of the frame 24 and a sensor etc. is attached to the beam 117. However, the beam 117 may be provided at a position other than the bottom of the frame 24. Alternatively, the beam 117 may be omitted and a sensor may be attached to the beam 111 or the beam 112.

As described above, the frame 24 of the screen speaker device 101 can be rotated around the rotation shaft 113 relative to the beam 112. Next, the rotation shaft 113 will be more specifically described.

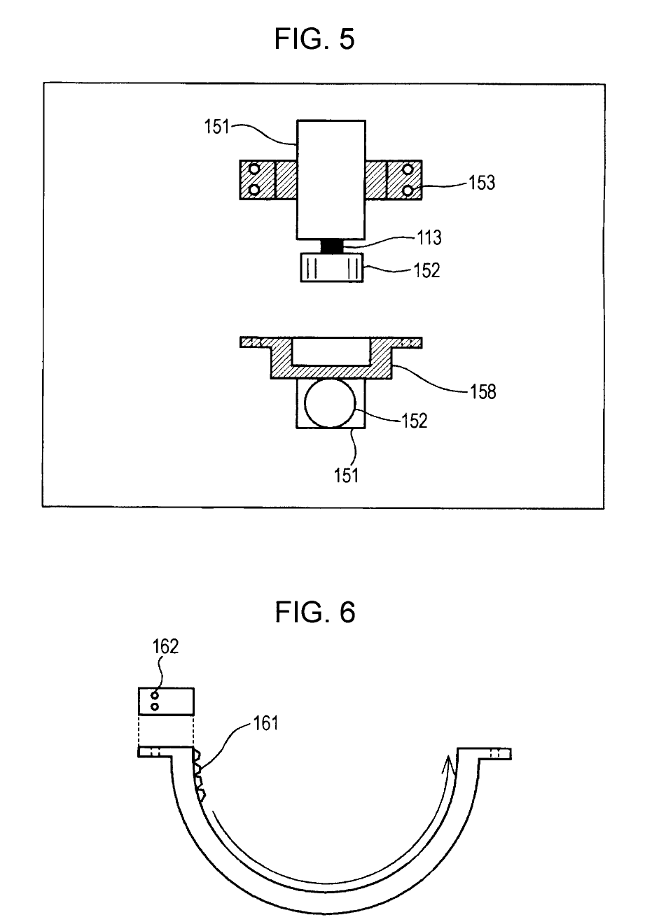

Referring to FIG. 5, the rotation shaft 113 is a shaft that connects a motor 151 with a pulley 152. The motor 151 is connected to a power source (not shown). Also, though not shown in FIG. 5, the motor 151 is connected to a control unit that controls the rotational speed and rotational direction of the motor 151. The motor 151 is fixed to the beam 112 with a fixing jig 153. The fixing jig 153 also has holes for fixture of the fixing jig 153 to the beam 112 with bolts. The bolts are inserted through the holes of the fixing jig 153 and the tap holes 115 of the beam 112, and hence the motor 151 is fixed to the beam 112.

The pulley 152 is configured to mesh with protrusions and recesses of a belt 161. The belt 161 has the protrusions and the recesses like those of a gear as shown in FIG. 6. When the motor 151 is driven, the pulley 152 is rotated. When the pulley 152 is rotated, the belt 161 meshing with the pulley 152 is moved. The belt 161 also has holes 162 at both ends for fixture of the belt 161 to the beam 111 with bolts. Thus, when the belt 161 is moved, the beam 111 is moved. In this case, the beam 111 is rotated around the rotation shaft 113.

Next, the rotation control of the motor 151 will be described. First, an example is described herein, in which the screen speaker device 101 as shown in FIG. 3 is rotated to a desirable position of the user. Also, the desirable position of the user described herein is a position at which sound from the screen speaker device 101 can be transmitted to the user without an acoustic transmission loss, and at which the user is located in front of the screen speaker device 101.

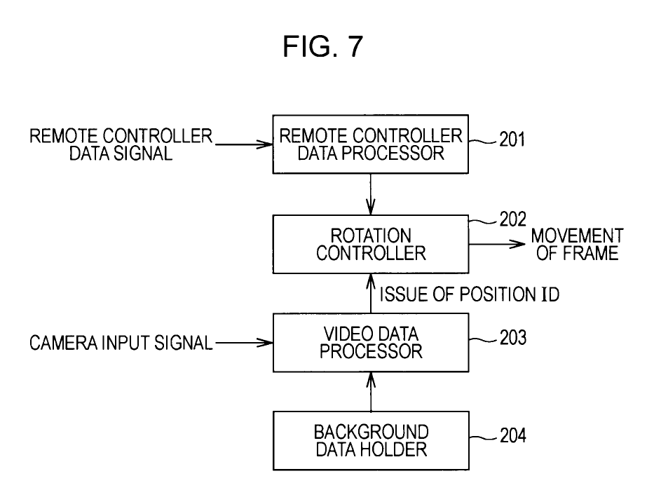

FIG. 7 is a block diagram relating to a control unit that controls the motor 151 such that the screen speaker device 101 faces the user. The control unit shown in FIG. 7 includes a remote controller data processor 201, a rotation controller 202, a video data processor 203, and a background data holder 204.

The remote controller data processor 201 processes signals from a remote controller (not shown) that is operated when the volume etc. of sound output from the screen speaker device 101 is adjusted. The rotation controller 202 controls the rotational direction, rotational speed, and rotational angle of the motor 151. When the motor 151 is driven under the control of the rotation controller 202, the frame 24 (the frame 24 to which the beam 111 is fixed) of the screen speaker device 101 is rotated.

The video data processor 203 processes input signals from a camera (not shown), recognizes the position of the user, and issues a position ID that represents the recognized position to the rotation controller 202. The rotation controller 202 controls the rotational angle etc. of the motor 151 on the basis of the position ID. A camera that supplies the video data processor 203 with video data is attached to, for example, the beam 112 (FIG. 4) of the screen speaker device 101, so that the camera captures an image of the room in which the screen speaker device 101 is disposed.

It is to be noted that the image captured by the camera may be movie or a still image. In the case of the still image, still images are preferably continuously captured at a predetermined interval such that the position of the user is recognizable at the predetermined interval.

The background data holder 204 holds the video captured by the camera. The background data holder 204 holds the background of the room as an image. The background of the room is assumed herein as the image of furniture or the like in the room, for example, a chair or a desk, which will not be basically moved. The video data processor 203 compares the video supplied from the camera with the background held in the background data holder 204. The video data processor 203 finds out the difference between the video and the background to recognize the position of the user.

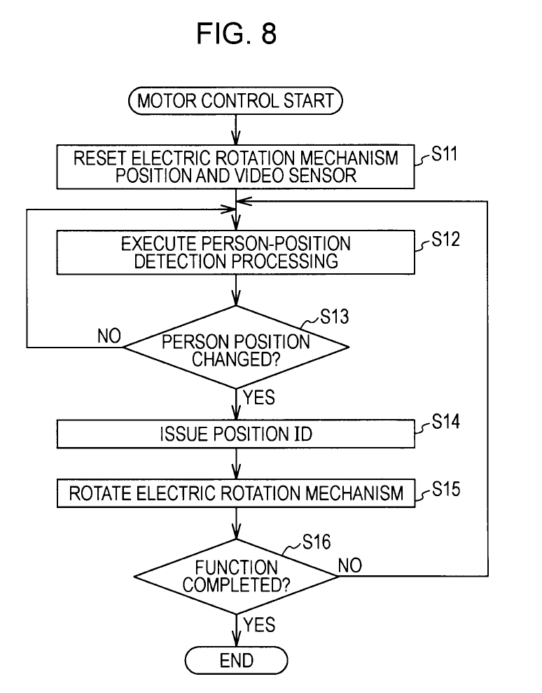

The processing performed by the control unit shown in FIG. 7 will be more specifically described with reference to a flowchart in FIG. 8. In step S11, an electric rotation mechanism position, a video sensor, etc., are reset. In step S11, the data held in the rotation controller 202 (the data such as the angle at the previous end) is reset, and the previous processing result etc. of the video data processor 203 is reset.

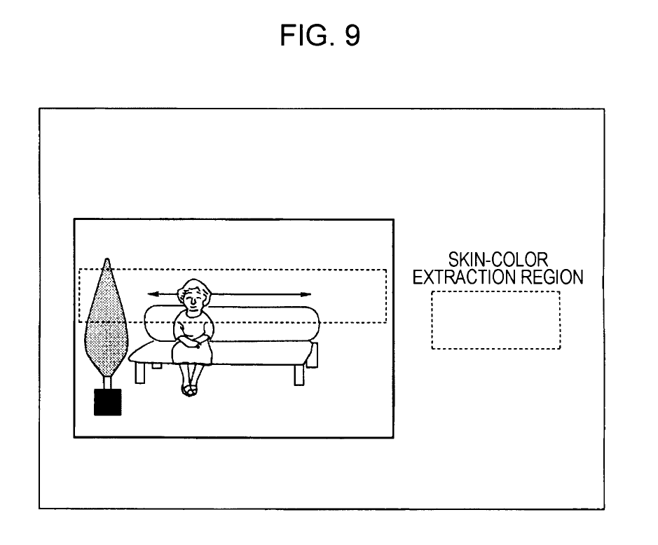

In step S12, person-position detection processing is executed. The video data processor 203 detects a person position. The video data processor 203 has, for example, a function of detecting a human skin color, and a function of determining a parameter. It is assumed that the image captured with the camera is an image shown in FIG. 9 and image data of such an image is supplied to the video data processor 203.

A face region of the person is extracted from the image shown in FIG. 9 as a skin-color extraction region by the function of detecting a human skin color. The skin-color extraction region is an image within a rectangle indicated by a dotted line in FIG. 9, and includes the face of the user. A skin-color region is further extracted from the skin-color extraction region. The barycentric coordinates of the pixel group of the skin-color region is identified as the position of the user. Obtained for the skin-color extraction are pixels whose value representing hue is a predetermined value or larger when the pixel value thereof is within a predetermined range. The parameter at the position identified as the position of the user is determined by the function of determining a parameter. The parameter is output as a position parameter (a position ID).

The details for detection of a skin-color part of a user is disclosed in Japanese Unexamined Patent Application Publication No. 2007-74675 which has been previously filed by the applicant of this application.

In step S12, after the person-position detection processing is executed, the processing result is used. In step S13, it is determined whether the person position has been changed. If it is determined that the person position has not been changed, the flow returns to the processing in step S12, and processing of step S12 and subsequent thereto is repeated. That is, the condition whether the user moves or not is continuously monitored. If it is determined that the user has moved, processing shifting to step S14 is executed as processing on the basis of the determination.

In step S14, the rotation controller 202 is issued with the position ID. That is, if it is determined that the user has moved, the rotation controller 202 is issued with the position ID of the position after the user has moved. As described above, the position ID is an ID that specifies the position of the user in the room.

In step S15, the electric rotation mechanism is rotated. That is, the rotation controller 202 compares the supplied position ID with the previous position ID, and recognizes the direction and distance of the movement of the user. The rotation controller 202 controls the motor 151 on the basis of the recognition result. With this control, the rotation is controlled such that the front surface of the screen speaker device 101 is directed toward the position of the user.

In step S16, it is determined whether the function is completed. For example, it is determined that the function is completed upon an instruction of the remote controller (not shown) or when an interruption signal is input. Then, the processing of the flowchart shown in FIG. 8 is ended.

As described above, the screen speaker device 101 has the rotating function and the rotation is controlled in accordance with the position of the user. Hence, audio can be transmitted to the user without an acoustic transmission loss.

This is not limited to audio. For example, the same can be applied to video. That is, when the user is not located in front of a display with which video is provided for the user, the video may not be provided for the user at an optimal position and a display surface may be arranged at a dead angle. Thus, the front surface of the display is preferably located in front of the user.

The screen speaker device 101 has the function of a speaker. Alternatively, the screen speaker device 101 may have a function of providing video instead of the function of a speaker. Instead of the vibration members 31, a panel display (a monitor), such as a liquid crystal display, an organic EL display, or a PDP (Plasma Display Panel), may be attached to the frame 24 shown in FIG. 4.

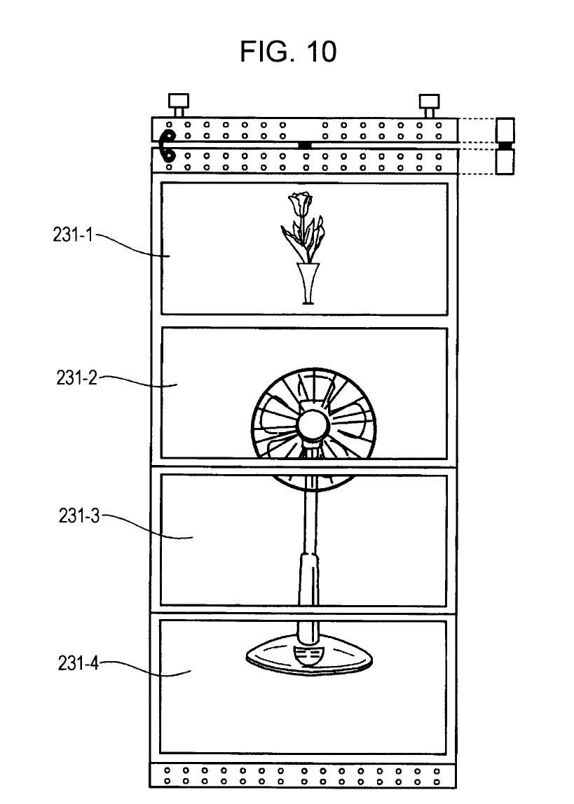

FIG. 10 is an illustration showing an example in which displays are attached to the frame 24. In the example shown in FIG. 10, displays 231-1 to 231-4 are attached. In the example shown in FIG. 10, the display 231-1 is driven as a single display, whereas the displays 231-2 to 231-4 are driven as three associated displays. As described above, the displays 231-1 to 231-4, instead of the vibration members 31, can be attached to the frame 24.

FIG. 3 shows the example of the screen speaker device 101, in which the three vibration members 31-1 to 31-3 are mounted, and FIG. 4 shows the configuration of the frame 24 corresponding to the screen speaker device 101 shown in FIG. 3. However, by modifying the configuration of the frame 24, four or more vibration members 31 may be attached to the frame 24. Also, as shown in FIG. 10, the four displays 231-1 to 231-4 can be mounted.

As described above, even when the displays 231 are attached to the frame 24, for example, by providing the control unit having the configuration shown in FIG. 7 and executing the processing of the flowchart shown in FIG. 8 similarly to the above-described embodiment, the front surfaces of the displays 231 can be directed toward the position of the user. Thus, the display surface can be prevented from being arranged at the dead angle, and can be directed in the most optimal direction for the user.

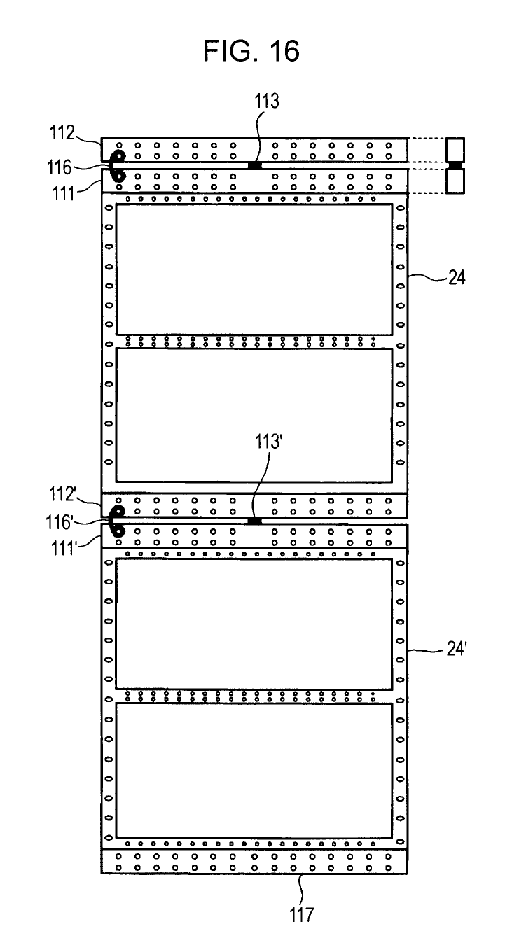

For example, as described below with reference to FIG. 16, a plurality of rotation shafts 113 may be provided at the frame 24 according to the present invention. In the case of the example shown in FIG. 10, as long as the rotation shafts 113 are provided respectively for the displays 231-1 to 231-4 (as long as the rotation shafts 113 are provided respectively for frames on which the displays 231-1 to 231-4 are provided), the displays 231-1 to 231-4 can be directed in different directions. As described above, when the plurality of rotation shafts 113 are provided, for example, a plurality of users can enjoy the videos from the displays at optimal angles for the plurality of users.

In the example shown in FIG. 10, the four displays 231-1 to 231-4 are mounted on the frame 24. In the example shown in FIG. 3, the three vibration members 31-1 to 31-3 are mounted on the frame 24. However, mounted on the frame 24 are not limited to the displays 231 or the vibration members 31, either of which have the same single function.

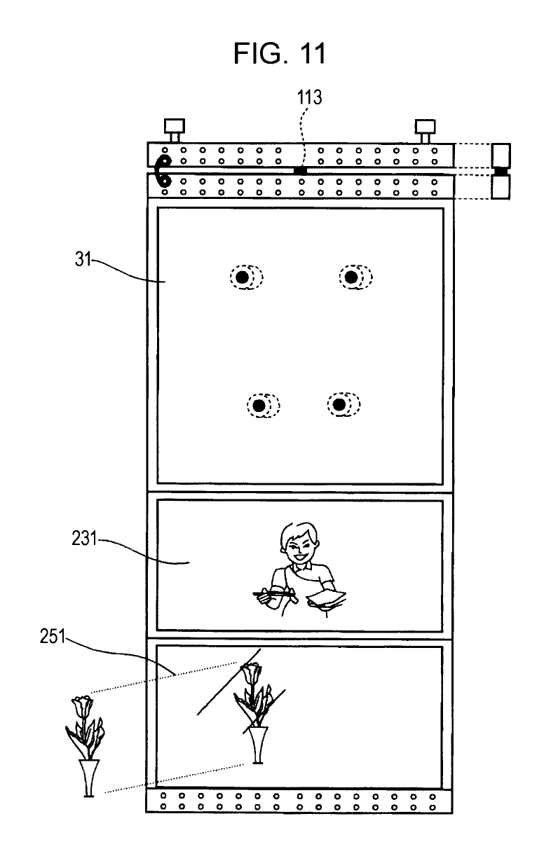

That is, mounted on the frame 24 may be members having different functions. For example, as shown in FIG. 11, the vibration member 31 may be mounted at the upper section of the frame 24, the display 231 may be mounted at the middle section, and a mirror 251 may be mounted at the lower section.

In the case of the configuration shown in FIG. 11, for example, audio corresponding to video of the display 231 can be output from the vibration member 31. Also, since the rotation of the rotation shaft 113 is controlled, the user can enjoy the video from the display 231 and the audio from the vibration member 31, at the optimal position for the user.

Also, by using a mechanism described below, the configuration shown in FIG. 11 can be modified into a configuration, in which the rotation shafts 113 are provided such that the vibration member 31, the display 231, and the mirror 251 are individually rotatable. When the plurality of rotation shafts 113 are provided, for example, the vibration member 31 can be directed in an optimal direction for a user A when audio from the vibration member 31 is provided for the user A. Also, the display 231 can be directed in an optimal direction for a user B located at a different position from the user A when video from the display 231 is provided for the user B. That is, different contents can be provided for users at different positions, in optimal directions for the users.

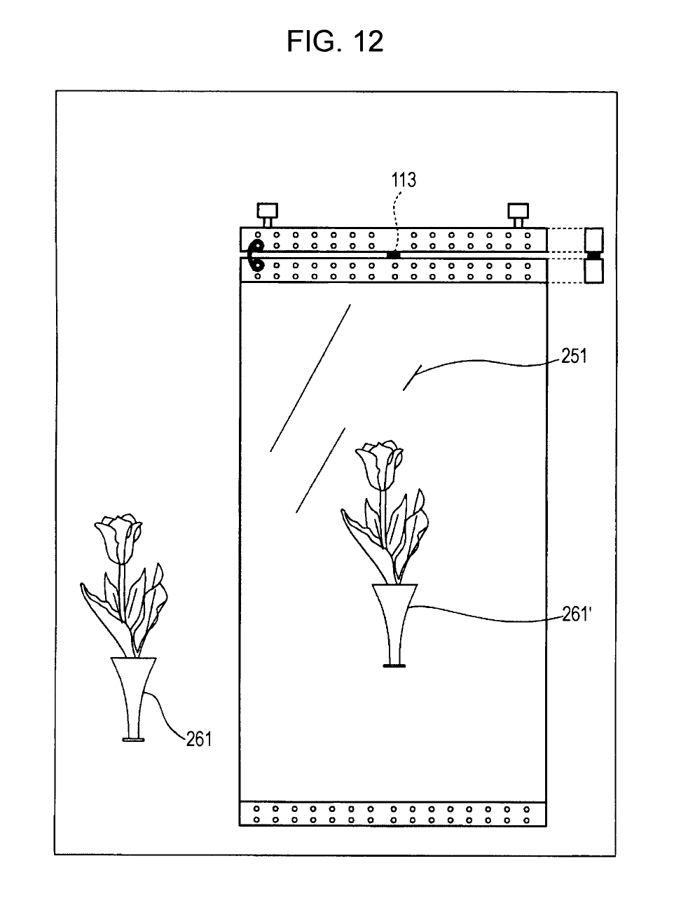

In the example shown in FIG. 11, the example is shown, in which the mirror 251 is mounted on the frame 24. The mirror 251 is used when the user looks at his/her image in the mirror 251. Also, as shown in FIG. 11, the mirror 252 is used when the user reflects a plant in the mirror 252 and enjoys looking at plant's image. Further, the mirror 251 may be used when the external light is reflected by the mirror 252 to expose the plant indirectly with the external light. Regarding such usage of the mirror 251, only the mirror 251 may be mounted on the frame 24 as shown in FIG. 12.

In the example shown in FIG. 12, only the mirror 251 is mounted on the frame 24. The mirror 251 reflects a plant 261 therein. When the mirror 251 is mounted on the frame 24 and the rotation shaft 113 is provided, the user can enjoy looking at a plant 261′ reflected in the mirror 251, at the position of the user. That is, even when the user changes his/her position, the mirror 251 can be rotated around the rotation shaft 113 toward the position of the user. Hence, the user can enjoy looking at the plant 261′ at the position of the user.

Also, when the mirror 251 is mounted on the frame 24, the plant 261 can be exposed to the external light as described above. That is, for example, although the position of light coming into a room through a window changes with time, as long as the rotation around the rotation shaft 113 is controlled in accordance with the change, the plant 261 can be exposed to the light reflected by the mirror 251 even when the incidence position of the light is changed. A mechanism for performing the above-described operation without a troublesome work of the user will be more specifically described.

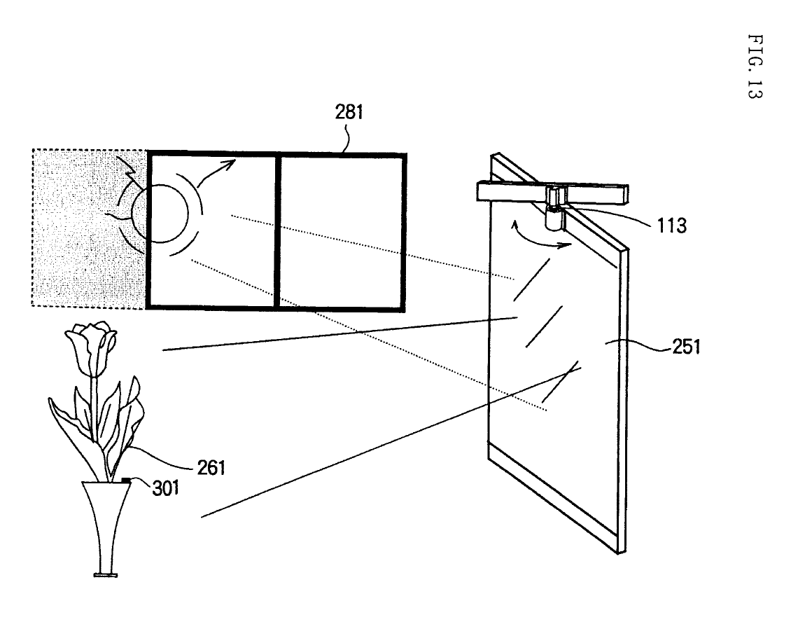

FIG. 13 is an illustration showing a configuration of a system for irradiating the plant 261 with the light reflected by the mirror 251. Light enters a room, in which a screen with the mirror 251 mounted on the frame 24 is disposed, through a window 281 of the room. The incident light strikes the mirror 251 and is reflected by the mirror 251. Then, the plant 261 is irradiated with the light. A photosensor 301 is disposed at the plant 261. The description continues with the example of the photosensor 301. However, the photosensor 301 may be replaced with any sensor as long as the sensor detects light. For example, a mechanism of measuring illuminance by using an illuminance sensor or a mechanism of measuring luminance by using a camera may be used instead of the photosensor 301.

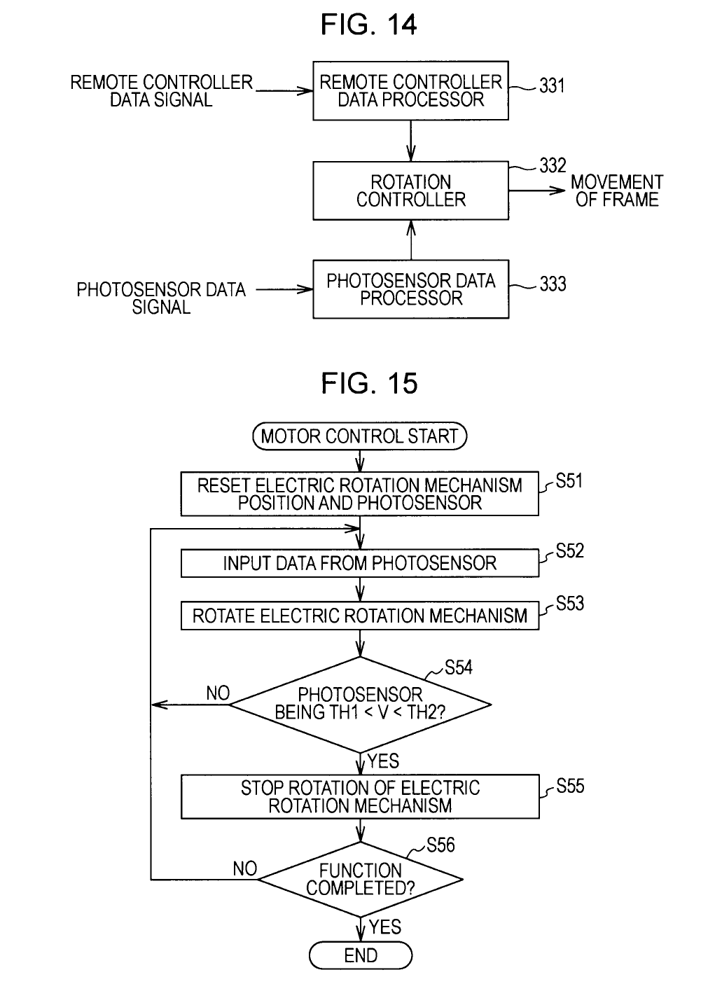

The photosensor 301 is provided only for measuring the quantity of light with which the plant 261 is irradiated. The angle of the mirror 251 is adjusted on the basis of the measurement result. The photosensor 301 is connected to a control unit (FIG. 14) through a wire or in a wireless manner. The control unit controls the rotation of the rotation shaft 113. The photosensor 301 supplies the control unit with the measurement result.

FIG. 14 is an illustration showing an example configuration of the control unit. The control unit shown in FIG. 14 includes a remote controller data processor 331, a rotation controller 332, and a photosensor data processor 333.

The remote controller data processor 331 processes signals from a remote controller (not shown). The rotation controller 332 controls the rotational direction, rotational speed, and rotational angle of the motor 151 (FIG. 5). When the motor 151 is driven under the control of the rotation controller 332, the frame 24 on which the mirror 251 is mounted (the frame 24 to which the beam 111 is fixed) is rotated.

The photosensor data processor 333 processes input signals from the photosensor 301 (FIG. 13) to measure the quantity of light (e.g., intensity) with which the plant 261 is irradiated. The photosensor data processor 333 determines whether the rotation is required on the basis of the measurement result, and supplies the rotation controller 332 with the determination result. The rotation controller 332 controls the rotational angle etc. of the motor 151 on the basis of the supplied determination result. When the motor 151 is rotated and hence the direction of the mirror 251 is changed, the direction of the reflected light is also changed. Thus, the measurement result of the photosensor 301 is changed. Observation of the change allows the position of the mirror 251 to be adjusted such that the position of the mirror 251 achieves an optimal angle.

Next, control for causing the plant 261 to be irradiated with the external light will be described with reference to a flowchart in FIG. 15. In step S51, an electric rotation mechanism position, the photosensor 301, etc., are reset. In step S51, the data held in the rotation controller 332 (the data such as the angle at the previous end) is reset, and the previous processing result etc. of the photosensor 301 is reset.

In step S52, the photosensor 301 starts measuring light intensity etc., and data of the measurement result is input from the photosensor 301. Here, the description continues on the basis of that the light intensity is measured. The light intensity measured by the photosensor 301 and representing the current light intensity of the light, with which the plant 261 is irradiated, is supplied to the photosensor data processor 333. The photosensor data processor 333 executes processing such as analysis.

In step S53, the electric rotation mechanism is driven, that is, the rotation shaft 113 is rotated by the motor 151. In step S53, when the electric rotation mechanism is rotated, the light intensity measured by the photosensor 301 may be changed. In order to stop the rotation at a position at which the changed light intensity becomes optimal, in step S54, it is determined whether the light intensity measured with the photosensor 301 is within a range defined by predetermined thresholds. Here, a threshold TH1 and a threshold TH2 are set for the thresholds. The threshold TH1 and the threshold TH2 are values satisfying the relationship of threshold TH1<threshold TH2.

Assuming that the light intensity measured with the photosensor 301 is an intensity V, it is determined in step S54 whether the following condition is satisfied. The intensity V with which the condition is satisfied is an optimal light intensity V of the light with which the plant 261 is irradiated.

Threshold TH1<intensity V<threshold TH2

The photosensor data processor 333 determines whether the measurement result supplied from the photosensor 301 satisfies this condition, and supplies the rotation controller 332 with the determination result. If the determination result indicates that the condition is not satisfied, the rotation controller 332 controls the motor 151 to rotate the motor 151. If the condition is satisfied, the rotation controller 332 stops the rotation of the motor 151.

In step S54, if it is determined that the light intensity V measured with the photosensor 301 does not satisfy the condition of threshold TH1<intensity V<threshold TH2, the flow returns to step S52, and processing of step S52 and subsequent thereto is repeated. Repeating the processing from step S52 through step S54 achieves the state in which the condition of threshold TH1<intensity V<threshold TH2 is satisfied. The state in which the condition of threshold TH1<intensity V<threshold TH2 is satisfied is a state in which the plant 261 is irradiated with a proper quantity of light.

In other words, repeating the processing from step S52 through S54 achieves the state in which the plant 261 is irradiated with the proper quantity of light. Thus, in step S54, if it is determined that threshold TH1<intensity V<threshold TH2 is satisfied, the flow goes on to processing in step S55, in which the rotation of the electric rotation mechanism is stopped.

In step S56, it is determined whether the function is completed. For example, it is determined that the function is completed upon an instruction of a remote controller (not shown) or when an interruption signal is input. Then, the processing of the flowchart shown in FIG. 15 is ended. In contrast, in step S56, if it is determined that the function is not completed, the flow returns to the processing in step S52, and processing of step S52 and subsequent thereto is repeated. Repeating the processing results in the direction of the external light through the window 281 being changed. The direction of the mirror 251 can be changed to a proper angle when the light intensity of the light reflected by the mirror 251 is changed.

As described above, since the rotation of the mirror 251 having the rotating function is controlled and the control is performed on the basis of the measurement result from the photosensor 301, the plant 261 can be irradiated with the external light for a long time without a troublesome work of the user.

The example, in which the plant 261 is exposed to the light, has been described. However, various usages can be considered, for example, irradiating laundry with light, or illuminating an area around user's hands with light. Even for a usage in which such a predetermined object is irradiated with light, the above-described configuration and processing can be applied to the usage.

In the embodiment described with reference to FIGS. 12 to 15, the example has been described, in which only the single mirror 251 is mounted on the frame 24. However, a plurality of mirrors 251 with different rotation shafts may be mounted on the frame 24. When the configuration has the plurality of mirrors 251, the mirrors 251 can be directed in different directions, so that plants at different positions can be irradiated with light in optimal ways for the plants.

Also, for optimal irradiation of light, the above-described threshold TH1 and threshold TH2 may be properly set. For example, when the intensity of light for irradiation of the plant 261 is desired to be different from the intensity of light for irradiation of the area around user's hands, the threshold TH1 and threshold TH2 may be set to obtain desirable intensities.

Next, the configuration of the frame 24 provided with the plurality of rotation shafts 113 will be described. FIG. 16 is an illustration showing a configuration of the frame 24 provided with two rotation shafts. In the example shown in FIG. 16, the upper frame represents a frame 24 whereas the lower frame represents a frame 24′.

The beam 111 is fixed to the top of the frame 24. The beam 111 is rotatably connected to the beam 112 through the rotation shaft 113. This part of the configuration is similar to that of the frame 24 shown in FIG. 4. Though not shown in FIG. 16, the wheel 23A and the wheel 23B are fixed to the beam 112 similarly to the beam 112 shown in FIG. 4 to allow the movement along the guide 22 (FIG. 3) provided in the ceiling 21.

A beam 112′ is fixed to the bottom of the frame 24. The beam 112′ has a configuration and a function similar to those of the beam 112. The beam 112′ is rotatably connected to a beam 111′ through a rotation shaft 113′. The beam 111′ has a configuration and a function similar to those of the beam 111. Also, the rotation shaft 113′ has a configuration and a function similar to those of the rotation shaft 113.

The beam 111′ is fixed to the frame 24′. Since the beam 111′ is attached rotatably around the rotation shaft 113′, the frame 24′ is attached rotatably relative to the frame 24. The beam 117 is fixed to the bottom of the frame 24′.

The rotation shaft 113 has a configuration basically similar to that of the rotation shaft 113′. The configuration includes the motor 151 etc. as described with reference to FIGS. 5 and 6. With the configuration shown in FIG. 16, the frame 24 is rotated around the rotation shaft 113, and the frame 24′ is rotated around the rotation shaft 113′. The frames 24 and 24′ can be individually rotated.

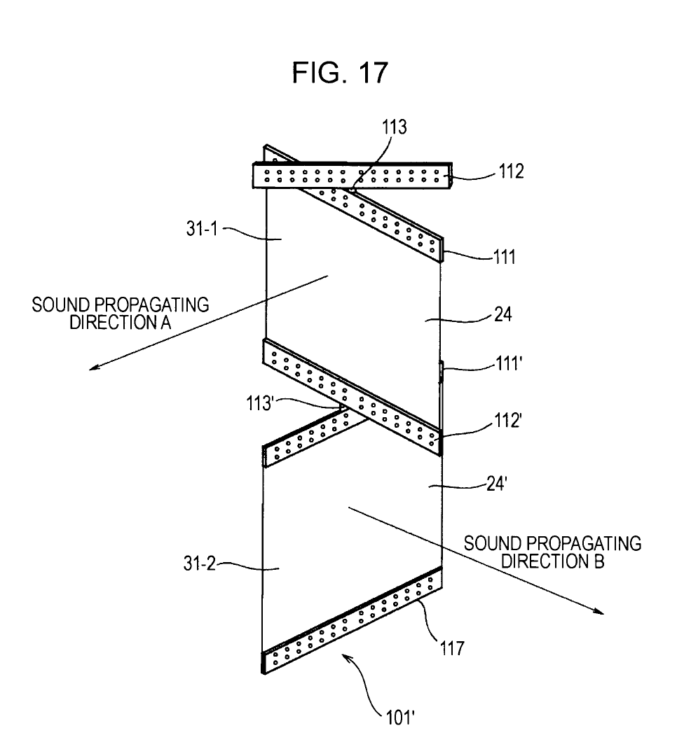

Thus, as shown in FIG. 17, the frame 24 and the frame 24′ can be directed in different directions. FIG. 17 shows an example in which the vibration member 31-1 is mounted on the frame 24, and the vibration member 31-2 is mounted on the frame 24′. As described above, when the vibration member 31-1 or the vibration member 31-2 is mounted on the frame 24 (24′), the configuration can be used as a screen speaker device 101′.

As shown in FIG. 17, sound from the vibration member 31-1 of the screen speaker device 101′ is output in a sound propagating direction A, which is the front direction of the vibration member 31-1, and sound from the vibration member 31-2 is output in a sound propagating direction B, which is the front direction of the vibration member 31-2. The propagating direction A differs from the propagating direction B. That is, since the direction of the vibration member 31-1 differs from the direction of the vibration member 31-2, the sounds can be output in the different directions. This embodiment can provide outputting of the sounds in the different directions.

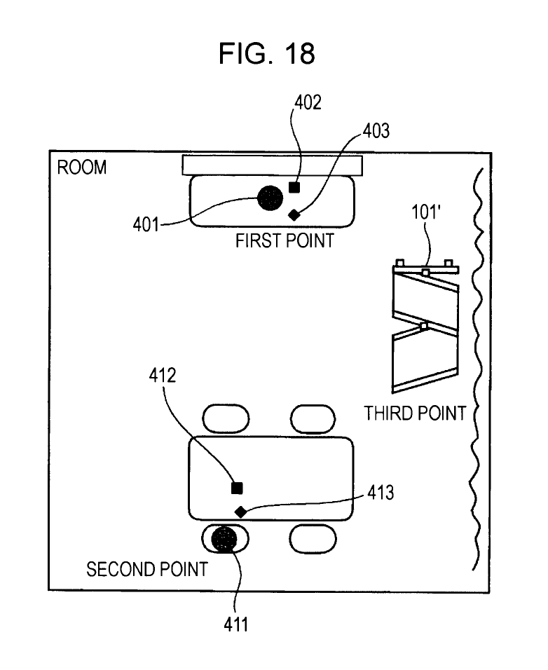

Specific examples will be described below in addition to the advantage of outputting of the sounds in the different directions. FIG. 18 is an illustration in a pseudo manner showing a room in which the screen speaker device 101′ is disposed.

A user 401 is located at a first point. A remote controller 402 that is operated by the user 401, and a sensor 403 that collects information relating to sound near the user 401 are located near the user 401. Similarly, a user 411 is located at a second point. A remote controller 412 that is operated by the user 411, and a sensor 413 that collects information relating to sound near the user 411 are located near the user 411.

The screen speaker device 101′ is disposed at a third point. In the state shown in FIG. 18, the screen speaker device 101′ to which this embodiment is applied can output sound toward the user 401 at the first point, and output sound toward the user 411 located at the second point, simultaneously. Thus, the sounds without an acoustic transmission loss can be provided for the user 401 and the user 411.

When the same sound is output from the vibration member 31-1 and the vibration member 31-2, the user 401 and the user 411 listen to the same sound. Since the vibration member 31-1 and the vibration member 31-2 are directed in optimal directions respectively for the users, the sound can be the optimal sound for both users.

When different sounds are output from the vibration member 31-1 and the vibration member 31-2, in an ordinary situation, the users may have difficulty in listening to the sounds because the different sounds are mixed. However, since the vibration member 31-1 and the vibration member 31-2 are directed in the optimal directions respectively for the users, each user can listen to the sound from the corresponding one of the vibration member 31-1 and the vibration member 31-2. Thus, as a result, when the different sounds are output from the vibration member 31-1 and the vibration member 31-2, the desirable sounds can be respectively provided for the users.

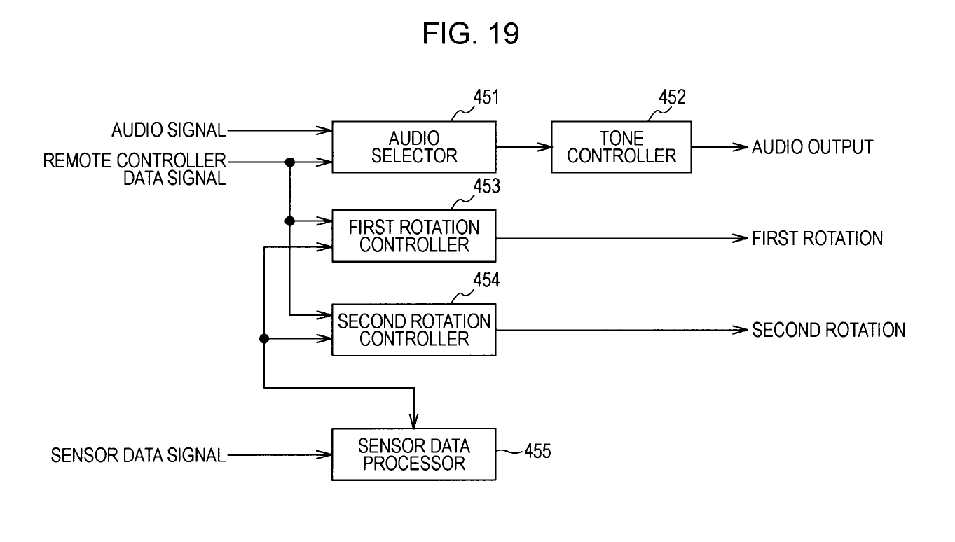

To allow the above usage, a control unit that controls the rotation of the rotation shaft 113 and the rotation of the rotation shaft 113′ of the screen speaker device 101′ has a configuration shown in FIG. 19. The control unit shown in FIG. 19 includes an audio selector 451, a tone controller 452, a first rotation controller 453, a second rotation controller 454, and a sensor data processor 455.

An external audio signal is input to the audio selector 451. To output the same audio to different channels, control is performed such that an input audio signal is output to the different channels. To output different audios to different channels, control is performed such that input different audio signals are respectively distributed into the different channels to cause audios to be output through the different channels. An example is described herein, in which the different channels are two channels. One channel of the two channels corresponds to a speaker function including the vibration member 31-1, and the other channel corresponds to a speaker function including the vibration member 31-2.

The audio selector 451 performs control such as selection of a channel to which an input audio signal is output, on the basis of remote controller data from the remote controller 402 and the remote controller 412.

The tone controller 452 performs filter calculation to correct the volume and various transmission characteristics, and outputs audio signals after the calculation respectively to the vibration member 31-1 and the vibration member 31-2.

The first rotation controller 453 controls the rotation of the rotation shaft 113. The control is performed on the basis of the remote controller data from the remote controller 402 and data from the sensor data processor 455. Similarly, the second rotation controller 454 controls the rotation of the rotation shaft 113′. The control is performed on the basis of the remote controller data from the remote controller 412 and data from the sensor data processor 455.

Sensor data as the measurement results from the sensor 403 and the sensor 413 is input to the sensor data processor 455. The sensor data processor 455 analyses the sensor data. The analysis result is supplied to the first rotation controller 453 and the second rotation controller 454. The sensor 403 and the sensor 413 may be sensors that can measure volumes. Herein, the description continues on the basis of that the sensor 403 and the sensor 413 are microphones.

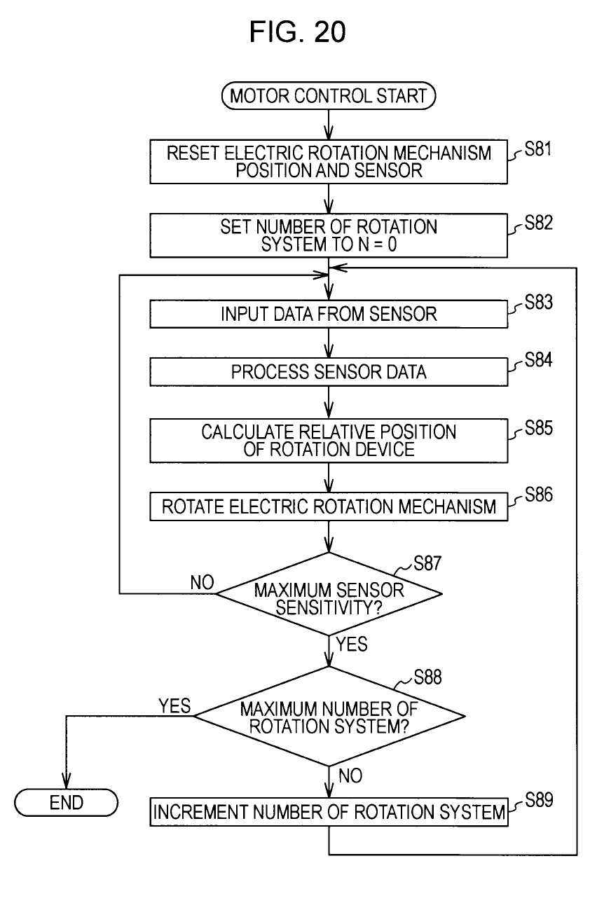

An operation of the control unit shown in FIG. 19 will be described with reference to a flowchart in FIG. 20. In step S81, an electric rotation mechanism position, sensors 403, 413, etc., are reset. In step S81, data held in the first rotation controller 453 and the second rotation controller 454 (the data such as the angles at the previous end) is reset, and the previous processing results etc. of the sensors 403, 413 are reset.

In step S82, the value of a rotation system is set to N=0. The rotation system is a system including a single rotation shaft, and a frame or a vibration member that is rotated around the rotation shaft. For example, in the exemplified configuration shown in FIG. 17, the rotation shaft 113 and the frame 24 (the vibration member 31-1) define a single rotation system, and the rotation shaft 113′ and the frame 24′ (the vibration member 31-2) define another single rotation system. Thus, the screen speaker device 101′ shown in FIG. 17 includes two rotation systems.

The description continues on the basis of that the control of the rotation shaft is successively performed for each of the rotation systems. To set one of the rotation systems as a control target, numbers are allocated to the rotation systems. The processing in step S82 is processing for initializing the number for the rotation system as the control target. Herein, the number for the rotation system including the rotation shaft 113 is set to “0”, and the number for the rotation system including the rotation shaft 113′ is set to “1”.

In step S83, sensor data is input from the sensor. Herein, since the number N for the rotation system has been set to “0”, the sensor data for controlling the rotation system including the rotation shaft 113 is input. It is assumed that the rotation system including the rotation shaft 113 is directed toward the position of the user 401 (FIG. 18). With such setting, the sensor data from the sensor 403 (FIG. 18) disposed near the user 401 is input and processed.

When the sensor data is supplied to the sensor data processor 455 from the sensor 403 in step S83, processing of the sensor data is executed in step S84. That is, the sensor 403 is a microphone in this case, and data of sound collected by the microphone is supplied as the sensor data. The sensor data is analyzed and the intensity of sound is measured.

The acoustic wave output from the vibration member 31-1 and the acoustic wave collected by the sensor 403 are not limited to acoustic waves within an audible range. For example, when processing is executed for adjusting the angle of the vibration member 31-1 (processing in the flowchart shown in FIG. 20), the processing may be performed by using sound that the user 401 cannot listen to.

That is, in this case, when sound is output from the vibration member 31-1, the sound is collected by the sensor 403, and the intensity of collected sound is measured. In step S85, the first rotation controller 453 calculates the relative position of a rotation device. Then, in step S86, the first rotation controller 453 controls the rotation of the rotation shaft 113 by using the calculation result. In step S87, it is determined whether the sensitivity of the sensor is a maximum value. If it is determined that the sensitivity is not the maximum value, the flow returns to the processing in step S83, and the processing of step S83 and subsequent thereto is repeated.

Repeating the processing from step S83 to S87 causes the vibration member 31-1 to be rotated to a position with the maximum intensity of sound. The position with the maximum intensity of sound consequently represents the state in which the user 401 faces the front surface of the vibration member 31-1, i.e., the state without an acoustic transmission loss. Repeating the processing from step S83 to S87 can shift the state to the above-described preferable state.

In step S87, if it is determined that the sensitivity of the sensor is maximum, the flow goes on to processing in step S88. In step S88, it is determined whether the number N for the rotation system is a maximum value. In this case, since the maximum value of the number N is “1”, if the value of the number N when the determination in step S88 is made is 1 or smaller, the flow goes on to processing in step S89.

In step S89, the number for the rotation system is incremented only by one. Since the number is incremented only by one, the rotation system as the processing target is changed. The processing of step S83 and subsequent thereto is repeated for the changed rotation system.

When the two rotation shafts 131, 131′ are provided like the screen speaker device 101′ shown in FIG. 17, the second rotation shaft (in this case, the rotation shaft 131′) correlates with the first rotation shaft (in this case, the rotation shaft 113). When the control for the first rotation system has been completed, the processing shifts to the control for the next rotation system. The relative rotational angle of the second rotation system is determined, and the control for the second rotation system is performed on the basis of the determination. As described above, the control for the second rotation system is performed similarly to the control for the first rotation system.

In contrast, if it is determined that the number for the rotation system is the maximum value in step S88, this indicates that the processing for the rotations of all rotation systems are completed. Hence, the processing in the flowchart shown in FIG. 20 is ended.

As described above, the vibration members 31 of the screen speaker device 101′ with the plurality of rotation shafts are directed toward optimal positions respectively for the users.

The control for such a device with the plurality of rotation shafts may not be applied only to a speaker that outputs audio like the screen speaker device 101′. The control can be applied to the other devices. As described above, a plurality of members having the same function may be mounted on a frame 24, or a plurality of members having different functions may be mounted on a frame 24. Also, the plurality of rotation shafts may be provided. Thus, the following application examples may be provided by applying this embodiment thereto.

For example, as described above with reference to FIG. 10, a configuration can be made by applying the present invention thereto, the configuration in which displays are mounted on the frame 24 and the frame 24′ and the displays are directed respectively in different directions such that videos etc. are respectively provided from the displays for users located in different directions.

Also, for example, as described above with reference to FIG. 11, a configuration can be made by applying the present invention thereto, the configuration in which members having different functions, such as a vibration member, a display, and a mirror, may be mounted and directed respectively in different directions. Thus, for example, the vibration member can be directed toward a user who enjoys music, the display can be directed toward a user who enjoys video, and the mirror can be directed to a plant to be exposed to light.

As described above, with the present invention, members having various functions, such as a plurality of speakers, displays, or mirrors, etc., can be attached to rotatable frame structures with a plurality of rotation shafts, in addition to a function as a screen and a partition. In addition, the configuration allows these functions to be moved to the proper positions depending on the situations, and to be rotated around the rotation shafts at the positions after the movement. Therefore, new advantages can be expected with the plurality of frame structures.

The device to which this embodiment is applied can be used in facilities with ceilings, such as family rooms, meeting rooms, movie theaters, and stages.

Also, the screen speaker device 101 (101′) exemplified as this embodiment is a screen speaker device having a frame structure for increasing an audio transmission effect. The frame structure of this screen speaker device has a frame mechanism, to which a rotation mechanism for controlling a sound propagating direction, i.e., directivity can be attached, and to which a sensor etc. for detecting the position of a person can be attached. As a result, sound that is optimal for a user can be provided for the user no matter where the user listens to the sound. Also, by using the frame structure, a video flat panel can be attached. An optimal angle of view can be reliably provided at the position of the user.

The series of processing described above (for example, the processing relating to the control for the rotation shaft 131) may be executed by hardware or software. For execution of the series of processing with software, a program of the software may be pre-installed in dedicated hardware of a computer, or may be installed from a program recording medium to a general personal computer etc. that can execute various functions upon installation of various programs.

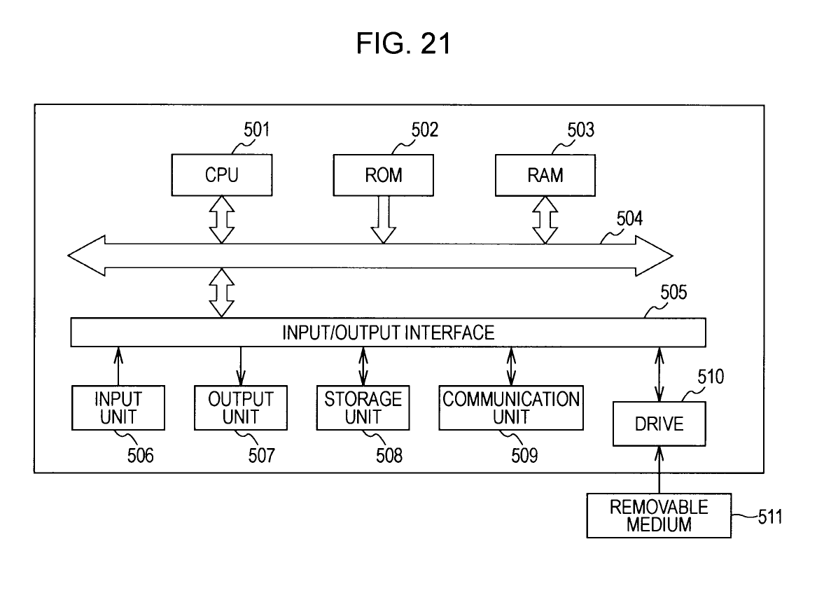

FIG. 21 is a block diagram showing a configuration example of hardware for a personal computer which executes the series of processing with a program. In the computer, a CPU (Central Processing Unit) 501, a ROM (Read Only Memory) 502, a RAM (Random Access Memory) 503 are connected to each other through a bus 504.

Also, an input/output interface 505 is connected to the bus 504. Connected to the input/output interface 505 are an input unit 506, such as a keyboard, a mouse, or a microphone; an output unit 507, such as a display or a speaker; a storage unit 508, such as hard disk or a nonvolatile memory; a communication unit 509 such as a network interface; and a drive 510 that drives a removable medium 511, such as a magnetic disk, an optical disc, an magneto-optical disk, or a semiconductor memory.

In the computer with the above-described configuration, for example, the CPU 501 loads the RAM 503 with the program stored in the storage unit 508 through the input/output interface 505 and the bus 504, and executes the program, thereby performing the series of processing.

The program executed by the computer (the CPU 501) may be provided, for example, by the removable medium 511 that is a package medium storing the program, such as a magnetic disk (including a flexible disk), an optical disc (a CD-ROM (Compact Disc-Read Only Memory), a DVD (Digital Versatile Disc) etc.), a magneto-optical disk, or a semiconductor memory. Alternatively, the program may be provided through a wired or wireless transmission medium, such as a local-area network, the Internet, or digital satellite broadcasting.

The installation of the program may be installed into the storage unit 508 through the input/output interface 505 by mounting the removable medium 511 on the drive 510. Alternatively, the program may be installed into the storage unit 508 by receiving the program by the communication unit 509 through a wired or wireless transmission medium. Still alternatively, the program may be pre-installed in the ROM 502 or the storage unit 508.

The program that is executed by a computer may be a program for performing the processing in time series in order that is described in this description, or may be a program for performing the processing in parallel or at necessary timing such as when a call is made.

In this description, the system represents a whole device including a plurality of devices.

Embodiments of the present invention are not limited to the embodiments described above, and various modifications may be made within the scope of the present invention.

1. A screen comprising:
a rotation section that rotates a frame having a predetermined shape,
wherein the rotation of the frame is controlled such that the frame is directed in a predetermined direction.

2. The screen according to claim 1, wherein the rotation section is provided for each of a plurality of the frames, and rotation of each frame is controlled.

3. The screen according to claim 1, wherein a vibration member is mounted on the frame.

4. The screen according to claim 3, wherein the rotation section controls the rotation such that the vibration member is directed toward a position of a user.

5. The screen according to claim 2,
wherein a vibration member is mounted on each frame, and
wherein each rotation section controls the rotation such that the corresponding vibration member is directed toward a position of a user.

6. The screen according to claim 3, wherein the rotation section analyzes sound collected by a sensor that collects sound from the vibration member, and controls the rotation such that an intensity of the sound becomes a proper intensity.

7. The screen according to claim 1, wherein a display is mounted on the frame.

8. The screen according to claim 7, wherein the rotation section controls the rotation such that the display is directed toward a position of a user.

9. The screen according to claim 2,
wherein a display is mounted on each frame, and
wherein each rotation section controls the rotation such that the corresponding display is directed toward a position of a user.

10. The screen according to claim 1, wherein a mirror is mounted on the frame.

11. The screen according to claim 10, wherein the rotation section controls the rotation such that the mirror is directed toward a position of a predetermined object.

12. The screen according to claim 2,
wherein a mirror is mounted on each frame, and
wherein each rotation section controls the rotation such that the corresponding mirror is directed toward a position of a predetermined object.

13. The screen according to claim 10, wherein the rotation section measures an intensity of light with which the object is irradiated, and controls the rotation such that the measurement result falls within a predetermined range.

14. The screen according to claim 2, wherein members having different functions are mounted respectively on the plurality of frames.

15. The screen according to claim 1 further comprising a movement section that moves the frame.

16. A control method of a control section that controls a rotation section of a screen that includes a frame having a predetermined shape, the control method comprising the step of:
performing control on the basis of data input from an external sensor such that the frame is directed toward the sensor.

17. The control method according to claim 16, wherein rotation sections respectively provided for a plurality of the frames are individually controlled.

18. The control method according to claim 16, wherein a vibration member is mounted on the frame, and control is provided such that the vibration member is directed toward a position of a user.

19. The control method according to claim 18, wherein sound collected by a sensor that collects sound from the vibration member is analyzed, and control is provided such that an intensity of the sound becomes a proper intensity.

20. The control method according to claim 16, wherein a display is mounted on the frame, and control is provided such that the display is directed toward a position of a user.

21. The control method according to claim 16, wherein a mirror is mounted on the frame, and control is provided such that the mirror is directed toward a position of a predetermined object.

22. The screen according to claim 21, wherein an intensity of light with which the object is irradiated is measured, and control is provided such that the measurement result falls within a predetermined range.

23. A program that causes a computer to execute processing comprising the steps of:
controlling a control section that controls a rotation section of a screen that includes a frame having a predetermined shape; and
performing control on the basis of data input from an external sensor such that the frame is directed toward the sensor.

24. A recording medium that stores the program according to claim 23.

25. A screen comprising:
rotation means for rotating a frame having a predetermined shape,
wherein the rotation of the frame is controlled such that the frame is directed in a predetermined direction.
